(19) United States
(12) Patent Application Publication
(10) Pub. No.: US 2015/0107083 A1
(43) Pub. Date: Apr. 23, 2015

(54) HEAT STAKE JOINING

(71) Applicant: Apple Inc., Cupertino, CA (US)

(72) Inventors: Christopher D. Prest, Cupertino, CA (US); Matthew S. Scott, Cupertino, CA (US); Stephen P. Zadesky, Cupertino, CA (US); Richard W. Heley, Cupertino, CA (US); Dermot J. Stratton, Cupertino, CA (US); Joseph C. Poole, Cupertino, CA (US)

(21) Appl. No.: 14/374,561

(22) PCT Filed: Jul. 1, 2011
(86) PCT No.: PCT/US2011/042852

§ 371 Date: Dec. 15, 2014

(51) Int. Cl. B23P 19/04; B23P 19/10

(52) U.S. Cl. CPC B23P 19/04; B23P 19/10
USPC 29/505; 29/283.5

(57) ABSTRACT

Provided in one embodiment is a method, comprising: providing a first part comprising a protruding portion, wherein the protruding portion comprises an alloy that is at least partially amorphous; providing a second part comprising an opening; disposing the second part in proximity of the first part such that the protruding portion traversed through the opening; and mating the protruding portion and the opening at a first temperature to shape the protruding portion into an interlock joining the first part and the second part.

All publications, patents, and patent applications cited in this Specification are hereby incorporated by reference in their entirety.

### BACKGROUND

Bulk-solidifying amorphous alloys have been made in a variety of metallic systems. They are generally prepared by quenching from above the melting temperature to the ambient temperature. Generally, high cooling rates, such as one on the order of 10⁵° C./sec, are needed to achieve an amorphous structure. The lowest rate by which a bulk solidifying alloy can be cooled to avoid crystallization, thereby achieving and maintaining the amorphous structure during cooling, is referred to as the “critical cooling rate” for the alloy. In order to achieve a cooling rate higher than the critical cooling rate, heat has to be extracted from the sample. Thus, the thickness of articles made from amorphous alloys often becomes a limiting dimension, which is generally referred to as the “critical (casting) thickness.” A critical thickness of an amorphous alloy can be obtained by heat-flow calculations, taking into account the critical cooling rate.

Conventional methods of joining different structural components including soldering, welding, or mechanically fastening with a fastener. However, soldering and welding generally need to be carried out at a very high temperature, which often results in damage to the parts being joined. Furthermore, generally soldering becomes ineffective when used to join chemically dissimilar components. These challenges can become particularly exacerbated when components with low softening temperatures are to be joined.

Thus, a need exists to develop methods of joining different structural components without the difficulties of the conventional joining methods such as soldering and welding.

### SUMMARY

One embodiment provides a method, comprising: providing a first part comprising a protruding portion, wherein the protruding portion comprises an alloy that is at least partially amorphous; providing a second part comprising an opening; disposing the second part in proximity of the first part such that the protruding portion traversed through the opening; and mating the protruding portion and the opening at a first temperature to shape the protruding portion into an interlock joining the first part and the second part.

Another embodiment provides a method, comprising: providing an assembly, comprising: a first part comprising a protruding portion, wherein the protruding portion comprises an alloy that is at least partially amorphous; a second part comprising an opening; the second part being disposed in proximity of the first part such that the protruding portion traverses through the opening; and mating the protruding portion and the opening with a heated tip at a temperature between about a glass transition temperature Tg and about a crystallization temperature Tx of the alloy to shape the protruding portion into an interlock joining the first part and the second part.

An alternative embodiment provides a device comprising: a first part comprising a protruding portion, wherein the protruding portion comprises an alloy that is at least partially amorphous; a second part comprising an opening; the second part being disposed in proximity of the first part such that the protruding portion traverses through the opening; and an interlock joining the first part and the second part, wherein the protruding portion and the opening are interconnected to shape the protruding portion into the interlock.

Another embodiment provides a method, comprising: providing an assembly, comprising: a first part comprising a protruding portion, wherein the protruding portion comprises an alloy that is at least partially amorphous; a second part that is in contact with a portion of a base of the protruding portion; and compressing the protruding portion towards the second part at a temperature between about a glass transition temperature Tg and about a crystallization temperature Tx of the alloy to shape the protruding portion into an interlock joining the first part and the second part.

### BRIEF DESCRIPTION OF THE DRAWINGS

FIGS. 1(a)-1(d) provide a series of cartoons showing the process of joining two parts in one embodiment using a protrusion comprising an amorphous alloy in one embodiment.

FIGS. 2(a)-2(b) provide schematic drawings of a cross-sectional and a bird view of an assembly of parts of and a photograph of an assembly with an interlock, respectively, in one embodiment. The schematic as shown in FIG. 2(a) is a zoom-in version of the joining element and parts shown in the structure shown in FIG. 2(b).

FIGS. 3(a)-3(b) show schematic diagrams of a tip that can be used to press the protrusion of the substrate into an interlock in one embodiment. FIG. 3(b) shows a schematic of the tip in relation to the other parts of the components during the pressing process.

FIGS. 4(a)-4(c) provide illustrations of a process of mating a protruding part (not to scale) of the first part being compressed by a tip in the shape of a plunger. The protruding part is shown as separate from the first part by exaggeration merely to show that the first part and the protruding part need not be the same. Also shown in the figures are the gradual changes in the shape of the protruding part.

FIGS. 5(a)-5(c) show schematic diagrams of an assembly (with a stainless steel part (SUS) and an amorphous alloy part (VIT) being joined by the presently described joining element in one embodiment. FIGS. 5(b)-5(c) show the embodiments, in which the assembly shown in FIG. 5(a) is made into samples for different mechanical property measurement tests: tensile test (5(b)) and shear test (5(c)).

FIGS. 6(a)-6(b) show schematic diagrams of the joining element being form in one embodiment.

FIGS. 7(a)-7(b) show photographs of a tensile test specimen and of a shear test specimen, respectively, in one embodiment. Each specimen includes the joining element comprising an amorphous alloy with at least two different parts. In one embodiment, the dimensions of the specimen are described in FIGS. 5(b)-5(c).

FIG. 8 shows the results of tensile strength measurements (as in FIG. 7a) of an assembly made by the presently described heat staking method in one embodiment and the comparison thereof to several conventional stainless-to-stainless joints.

FIG. 9 shows the results of shear strength measurements of an assembly made by the presently described heat staking method in one embodiment and the comparison thereof to several conventional stainless-to-stainless joints.

FIGS. 10(a)-10(c) provide a series of cartoons showing the process of joining two parts in one embodiment using a protrusion comprising an amorphous alloy in one embodiment.

### DETAILED DESCRIPTION

### Phase

The term “phase” herein can refer to one that can be found in a thermodynamic phase diagram. A phase is a region of space (e.g., a thermodynamic system) throughout which all physical properties of a material are essentially uniform. Examples of physical properties include density, index of refraction, chemical composition and lattice periodicity. A simple description is that a phase is a region of material that is chemically uniform, physically distinct, and/or mechanically separable. For example, in a system consisting of ice and water in a glass jar, the ice cubes are one phase, the water is a second phase, and the humid air over the water is a third phase. The glass of the jar is another separate phase. A phase can refer to a solid solution, which can be a binary, tertiary, quaternary, or more, solution, or a compound, such as an intermetallic compound. As another example, an amorphous phase is distinct from a crystalline phase.

### Metal, Transition Metal, and Non-Metal

The term “metal” refers to an electropositive chemical element. The term “element” in this Specification refers generally to an element that can be found in a Periodic Table. Physically, a metal atom in the ground state contains a partially filled band with an empty state close to an occupied state. The term “transition metal” is any of the metallic elements within Groups 3 to 12 in the Periodic Table that have an incomplete inner electron shell and serve as transitional links between the most and the least electropositive in a series of elements. Transition metals are characterized by multiple valences, colored compounds, and the ability to form stable complex ions. The term “nonmetal” refers to a chemical element that does not have the capacity to lose electrons and form a positive ion.

Depending on the application, any suitable nonmetal elements, or their combinations, can be used. The alloy composition can comprise multiple nonmetal elements, such as at least two, at least three, at least four, or more, nonmetal elements. A nonmetal element can be any element that is found in Groups 13-17 in the Periodic Table. For example, a nonmetal element can be any one of F, Cl, Br, I, At, O, S, Se, Te, Po, N, P, As, Sb, Bi, C, Si, Ge, Sn, Pb, and B. Occasionally, a nonmetal element can also refer to certain metalloids (e.g., B, Si, Ge, As, Sb, Te, and Po) in Groups 13-17. In one embodiment, the nonmetal elements can include B, Si, C, P, or combinations thereof. Accordingly, for example, the alloy composition can comprise a boride, a carbide, or both.

A transition metal element can be any of scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, rutherfordium, dubnium, seaborgium, bohrium, hassium, meitnerium, ununnilium, unununium, and ununbium. In one embodiment, a BMG containing a transition metal element can have at least one of Sc, Y, La, Ac, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, and Hg. Depending on the application, any suitable transitional metal elements, or their combinations, can be used. The alloy composition can comprise multiple transitional metal elements, such as at least two, at least three, at least four, or more, transitional metal elements.

The presently described alloy or alloy “sample” or “specimen” alloy can have any shape or size. For example, the alloy can have a shape of a particulate, which can have a shape such as spherical, ellipsoid, wire-like, rod-like, sheet-like, flake-like, or an irregular shape. The particulate can have any suitable size. For example, it can have an average diameter of between about 1 micron and about 100 microns, such as between about 5 microns and about 80 microns, such as between about 10 microns and about 60 microns, such as between about 15 microns and about 50 microns, such as between about 15 microns and about 45 microns, such as between about 20 microns and about 40 microns, such as between about 25 microns and about 35 microns. For example, in one embodiment, the average diameter of the particulate is between about 25 microns and about 44 microns. In some embodiments, smaller particulates, such as those in the nanometer range, or larger particulates, such as those bigger than 100 microns, can be used.

The alloy sample or specimen can also be of a much larger dimension. For example, it can be a bulk structural component, such as an ingot, housing/casing of an electronic device or even a portion of a structural component that has dimensions in the millimeter, centimeter, or meter range.

### Solid Solution

The term “solid solution” refers to a solid form of a solution. The term “solution” refers to a mixture of two or more substances, which may be solids, liquids, gases, or a combination of these. The mixture can be homogeneous or heterogeneous. The term “mixture” is a composition of two or more substances that are combined with each other and generally capable of being separated. Generally, the two or more substances are not chemically combined with each other.

### Alloy

In some embodiments, the alloy powder composition described herein can be fully alloyed. In one embodiment, an “alloy” refers to a homogeneous mixture or solid solution of two or more metals, the atoms of one replacing or occupying interstitial positions between the atoms of the other; for example, brass is an alloy of zinc and copper. An alloy, in contrast to a composite, can refer to a partial or complete solid solution of one or more elements in a metal matrix, such as one or more compounds in a metallic matrix. The term “alloy” herein can refer to both a complete solid solution alloy that can give single solid phase microstructure and a partial solution that can give two or more phases.

Thus, a fully alloyed alloy can have a homogenous distribution of the constituents, be it a solid solution phase, a compound phase, or both. The term “fully alloyed” used herein can account for minor variations within the error tolerance. For example, it can refer to at least 90% alloyed, such as at least 95% alloyed, such as at least 99% alloyed, such as at least 99.5% alloyed, such as at least 99.9% alloyed. The percentage herein can refer to either volume percent or weight percentage, depending on the context. These percentages can be balanced by impurities, which can be in terms of composition or phases that are not a part of the alloy.

### Amorphous or Non-Crystalline Solid

An “amorphous” or “non-crystalline solid” is a solid that lacks lattice periodicity, which is characteristic of a crystal. As used herein, an “amorphous solid” includes “glass” which is an amorphous solid that softens and transforms into a liquid-like state upon heating through the glass transition phase. Generally, amorphous materials lack the long-range order characteristic of a crystal, though they can possess some short-range order at the atomic length scale due to the nature of chemical bonding. The distinction between amorphous solids and crystalline solids can be made based on lattice periodicity as determined by structural characterization techniques such as x-ray diffraction and transmission electron microscopy.

The terms “order” and “disorder” designate the presence or absence of some symmetry or correlation in a many-particle system. The terms “long-range order” and “short-range order” distinguish order in materials based on length scales.

The strictest form of order in a solid is lattice periodicity: a certain pattern (the arrangement of atoms in a unit cell) is repeated again and again to form a translationally invariant tiling of space. This is the defining property of a crystal. Possible symmetries have been classified in 14 Bravais lattices and 230 space groups.

Lattice periodicity implies long-range order. If only one unit cell is known, then by virtue of the translational symmetry it is possible to accurately predict all atomic positions at arbitrary distances. The converse is generally true, except, for example, in quasi-crystals that have perfectly deterministic tilings but do not possess lattice periodicity.

Long-range order characterizes physical systems in which remote portions of the same sample exhibit correlated behavior. This can be expressed as a correlation function, namely the spin-spin correlation function: G(x,x′)= [symbol] s(x),s(x′) [symbol] .

In the above function, s is the spin quantum number and x is the distance function within the particular system. This function is equal to unity when x=x′ and decreases as the distance |x−x′| increases. Typically, it decays exponentially to zero at large distances, and the system is considered to be disordered. If, however, the correlation function decays to a constant value at large |x−x′|, then the system can be said to possess long-range order. If it decays to zero as a power of the distance, then it can be called quasi-long-range order. Note that what constitutes a large value of |x−x′| is relative.

A system can be said to present quenched disorder when some parameters defining its behavior are random variables that do not evolve with time (i.e., they are quenched or frozen)—e.g., spin glasses. It is opposite to annealed disorder, where the random variables are allowed to evolve themselves. Embodiments herein include systems comprising quenched disorder.

The alloy described herein can be crystalline, partially crystalline, amorphous, or substantially amorphous. For example, the alloy sample/specimen can include at least some crystallinity, with grains/crystals having sizes in the nanometer and/or micrometer ranges. Alternatively, the alloy can be substantially amorphous, such as fully amorphous. In one embodiment, the alloy powder composition is at least substantially not amorphous, such as being substantially crystalline, such as being entirely crystalline.

In one embodiment, the presence of a crystal or a plurality of crystals in an otherwise amorphous alloy can be construed as a “crystalline phase” therein. The degree of crystallinity (or “crystallinity” for short in some embodiments) of an alloy can refer to the amount of the crystalline phase present in the alloy. The degree can refer to, for example, a fraction of crystals present in the alloy. The fraction can refer to volume fraction or weight fraction, depending on the context. A measure of how “amorphous” an amorphous alloy is can be amorphicity. Amorphicity can be measured in terms of a degree of crystallinity. For example, in one embodiment, an alloy having a low degree of crystallinity can be said to have a high degree of amorphicity. In one embodiment, for example, an alloy having a 60 vol % crystalline phase can have a 40 vol % amorphous phase.

### Amorphous Alloy or Amorphous Metal

An “amorphous alloy” is an alloy having an amorphous content of more than 50% by volume, preferably more than 90% by volume of amorphous content, more preferably more than 95% by volume of amorphous content, and most preferably more than 99% to almost 100% by volume of amorphous content. Note that, as described above, an alloy high in amorphicity is equivalently low in degree of crystallinity. An “amorphous metal” is an amorphous metal material with a disordered atomic-scale structure. In contrast to most metals, which are crystalline and therefore have a highly ordered arrangement of atoms, amorphous alloys are non-crystalline. Materials in which such a disordered structure is produced directly from the liquid state during cooling are sometimes referred to as “glasses.” Accordingly, amorphous metals are commonly referred to as “metallic glasses” or “glassy metals.” In one embodiment, a “bulk metallic glass” (“BMG”) can refer to an alloy, of which the microstructure is at least partially amorphous. However, there are several ways besides extremely rapid cooling to produce amorphous metals, including physical vapor deposition, solid-state reaction, ion irradiation, melt spinning, and mechanical alloying. Amorphous alloys can be a single class of materials, regardless of how they are prepared.

Amorphous metals can be produced through a variety of quick-cooling methods. For instance, amorphous metals can be produced by sputtering molten metal onto a spinning metal disk. The rapid cooling, on the order of millions of degrees a second, can be too fast for crystals to form, and the material is thus “locked in” a glassy state. Also, amorphous metals/alloys can be produced with critical cooling rates low enough to allow formation of amorphous structure in thick layers—e.g., bulk metallic glasses.

The terms “bulk metallic glass” (“BMG”), bulk amorphous alloys, and bulk solidifying amorphous alloys are used interchangeably herein. They refer to amorphous alloys having the smallest dimension at least in the millimeter range. For example, the dimension can be at least about 0.5 mm, such as at least about 1 mm, such as at least about 2 mm, such as at least about 4 mm, such as at least about 5 mm, such as at least about 6 mm, such as at least about 8 mm, such as at least about 10 mm, such as at least about 12 mm Depending on the geometry, the dimension can refer to the diameter, radius, thickness, width, length, etc. A BMG can also be a metallic glass having at least one dimension in the centimeter range, such as at least about 1.0 cm, such as at least about 2.0 cm, such as at least about 5.0 cm, such as at least about 10.0 cm. In some embodiments, a BMG can have at least one dimension at least in the meter range. A BMG can take any of the shapes or forms described above, as related to a metallic glass. Accordingly, a BMG described herein in some embodiments can be different from a thin film made by a conventional deposition technique in one important aspect—the former can be of a much larger dimension than the latter.

Amorphous metals can be an alloy rather than a pure metal. The alloys may contain atoms of significantly different sizes, leading to low free volume (and therefore having viscosity up to orders of magnitude higher than other metals and alloys) in a molten state. The viscosity prevents the atoms from moving enough to form an ordered lattice. The material structure may result in low shrinkage during cooling and resistance to plastic deformation. The absence of grain boundaries, the weak spots of crystalline materials in some cases, may, for example, lead to better resistance to wear and corrosion. In one embodiment, amorphous metals, while technically glasses, may also be much tougher and less brittle than oxide glasses and ceramics.

Thermal conductivity of amorphous materials may be lower than that of their crystalline counterparts. To achieve formation of an amorphous structure even during slower cooling, the alloy may be made of three or more components, leading to complex crystal units with higher potential energy and lower probability of formation. The formation of amorphous alloy can depend on several factors: the composition of the components of the alloy; the atomic radius of the components (preferably with a significant difference of over 12% to achieve high packing density and low free volume); and the negative heat of mixing the combination of components, inhibiting crystal nucleation and prolonging the time the molten metal stays in a supercooled state. However, as the formation of an amorphous alloy is based on many different variables, it can be difficult to make a prior determination of whether an alloy composition would form an amorphous alloy.

Amorphous alloys, for example, of boron, silicon, phosphorus, and other glass formers with magnetic metals (iron, cobalt, nickel) may be magnetic, with low coercivity and high electrical resistance. The high resistance leads to low losses by eddy currents when subjected to alternating magnetic fields, a property useful, for example, as transformer magnetic cores.

Amorphous alloys may have a variety of potentially useful properties. In particular, they tend to be stronger than crystalline alloys of similar chemical composition, and they can sustain larger reversible (“elastic”) deformations than crystalline alloys. Amorphous metals derive their strength directly from their non-crystalline structure, which can have none of the defects (such as dislocations) that limit the strength of crystalline alloys. For example, one modern amorphous metal, known as Vitreloy™, has a tensile strength that is almost twice that of high-grade titanium. In some embodiments, metallic glasses at room temperature are not ductile and tend to fail suddenly when loaded in tension, which limits the material applicability in reliability-critical applications, as the impending failure is not evident. Therefore, to overcome this challenge, metal matrix composite materials having a metallic glass matrix containing dendritic particles or fibers of a ductile crystalline metal can be used. Alternatively, a BMG low in element(s) that tend to cause embitterment (e.g., Ni) can be used. For example, a Ni-free BMG can be used to improve the ductility of the BMG.

Another useful property of bulk amorphous alloys is that they can be true glasses; in other words, they can soften and flow upon heating. This allows for easy processing, such as by injection molding, in much the same way as polymers. As a result, amorphous alloys can be used for making sports equipment, medical devices, electronic components and equipment, and thin films. Thin films of amorphous metals can be deposited as protective coatings via a high velocity oxygen fuel technique.

A material can have an amorphous phase, a crystalline phase, or both. The amorphous and crystalline phases can have the same chemical composition and differ only in the microstructure—i.e., one amorphous and the other crystalline. Microstructure in one embodiment refers to the structure of a material as revealed by a microscope at 25× magnification or higher. Alternatively, the two phases can have different chemical compositions and microstructures. For example, a composition can be partially amorphous, substantially amorphous, or completely amorphous.

As described above, the degree of amorphicity (and conversely the degree of crystallinity) can be measured by the fraction of crystals present in the alloy. The degree can refer to volume fraction of weight fraction of the crystalline phase present in the alloy. A partially amorphous composition can refer to a composition of at least about 5 vol % of which is of an amorphous phase, such as at least about 10 vol %, such as at least about 20 vol %, such as at least about 40 vol %, such as at least about 60 vol %, such as at least about 80 vol %, such as at least about 90 vol %. The terms “substantially” and “about” have been defined elsewhere in this application. Accordingly, a composition that is at least substantially amorphous can refer to one of which at least about 90 vol % is amorphous, such as at least about 95 vol %, such as at least about 98 vol %, such as at least about 99 vol %, such as at least about 99.5 vol %, such as at least about 99.8 vol %, such as at least about 99.9 vol %. In one embodiment, a substantially amorphous composition can have some incidental, insignificant amount of crystalline phase present therein.

In one embodiment, an amorphous alloy composition can be homogeneous with respect to the amorphous phase. A substance that is uniform in composition is homogeneous. This is in contrast to a substance that is heterogeneous. The term “composition” refers to the chemical composition and/or microstructure in the substance. A substance is homogeneous when a volume of the substance is divided in half and both halves have substantially the same composition. For example, a particulate suspension is homogeneous when a volume of the particulate suspension is divided in half and both halves have substantially the same volume of particles. However, it might be possible to see the individual particles under a microscope. Another example of a homogeneous substance is air where different ingredients therein are equally suspended, though the particles, gases and liquids in air can be analyzed separately or separated from air.

A composition that is homogeneous with respect to an amorphous alloy can refer to one having an amorphous phase substantially uniformly distributed throughout its microstructure. In other words, the composition macroscopically comprises a substantially uniformly distributed amorphous alloy throughout the composition. In an alternative embodiment, the composition can be of a composite, having an amorphous phase having therein a non-amorphous phase. The non-amorphous phase can be a crystal or a plurality of crystals. The crystals can be in the form of particulates of any shape, such as spherical, ellipsoid, wire-like, rod-like, sheet-like, flake-like, or an irregular shape. In one embodiment, it can have a dendritic form. For example, an at least partially amorphous composite composition can have a crystalline phase in the shape of dendrites dispersed in an amorphous phase matrix; the dispersion can be uniform or non-uniform, and the amorphous phase and the crystalline phase can have the same or a different chemical composition. In one embodiment, they have substantially the same chemical composition. In another embodiment, the crystalline phase can be more ductile than the BMG phase.

The methods described herein can be applicable to any type of amorphous alloys. Similarly, the amorphous alloys described herein as a constituent of a composition or article can be of any type. The amorphous alloy can comprise the element Zr, Hf, Ti, Cu, Ni, Pt, Pd, Fe, Mg, Au, La, Ag, Al, Mo, Nb, Be, or combinations thereof. Namely, the alloy can include any combination of these elements in its chemical formula or chemical composition. The elements can be present at different weight or volume percentages. For example, an iron “based” alloy can refer to an alloy having a non-insignificant weight percentage of iron present therein, the weight percent can be, for example, at least about 20 wt %, such as at least about 40 wt %, such as at least about 50 wt %, such as at least about 60 wt %, such as at least about 80 wt %. Alternatively, in one embodiment, the above-described percentages can be volume percentages, instead of weight percentages. Accordingly, an amorphous alloy can be zirconium-based, titanium-based, platinum-based, palladium-based, gold-based, silver-based, copper-based, iron-based, nickel-based, aluminum-based, molybdenum-based, and the like. In some embodiments, the alloy, or the composition including the alloy, can be substantially free of nickel, aluminum, or beryllium, or combinations thereof. In one embodiment, the alloy or the composite is completely free of nickel, aluminum, or beryllium, or combinations thereof.

For example, the amorphous alloy can have the formula (Zr, Ti)ₐ(Ni, Cu, Fe)_{b}(Be, Al, Si, B)_{c}, wherein a, b, and c each represents a weight or atomic percentage. In one embodiment, a is in the range of from 30 to 75. b is in the range of from 5 to 60, and c is in the range of from 0 to 50 in atomic percentages. Alternatively, the amorphous alloy can have the formula (Zr, Ti)_{b}(Ni, Cu)_{b}(Be)_{c}, wherein a, b, and c each represents a weight or atomic percentage. In one embodiment, a is in the range of from 40 to 75, b is in the range of from 5 to 50, and c is in the range of from 5 to 50 in atomic percentages. The alloy can also have the formula (Zr, Ti)ₐ(Ni, Cu)_{b}(Be)_{c}, wherein a, b, and c each represents a weight or atomic percentage. In one embodiment, a is in the range of from 45 to 65, b is in the range of from 7.5 to 35, and c is in the range of from 10 to 37.5 in atomic percentages. Alternatively, the alloy can have the formula (Zr)ₐ(Nb, Ti)_{b}(Ni, Cu)_{c}(Al)_{d}, wherein a, b, c, and d each represents a weight or atomic percentage. In one embodiment, a is in the range of from 45 to 65, b is in the range of from 0 to 10, c is in the range of from 20 to 40 and d is in the range of from 7.5 to 15 in atomic percentages. One exemplary embodiment of the aforedescribed alloy system is a Zr—Ti—Ni—Cu—Be based amorphous alloy under the trade name Vitreloy™, such as Vitreloy-1 and Vitreloy-101, as fabricated by Liquidmetal Technologies, CA, USA. Some examples of amorphous alloys of the different systems are provided in Table 1.

The amorphous alloys can also be ferrous alloys, such as (Fe, Ni, Co) based alloys. Examples of such compositions are disclosed in U.S. Pat. Nos. 6,325,868; 5,288,344; 5,368,659; 5,618,359; and 5,735,975, Inoue et al., Appl. Phys. Lett., Volume 71, p 464 (1997), Shen et al., Mater. Trans., JIM, Volume 42, p 2136 (2001), and Japanese Patent Application No. 200126277 (Pub. No. 2001303218 A). One exemplary composition is Fe₇₂Al₅Ga₂P₁₁C₆B₄. Another example is Fe₇₂Al₇Zr₁₀Mo₅W₂B₁₅. Another iron-based alloy system that can be used in the coating herein is disclosed in U.S. Patent Application Publication No. 2010/0084052, wherein the amorphous metal contains, for example, manganese (1 to 3 atomic %), yttrium (0.1 to 10 atomic %), and silicon (0.3 to 3.1 atomic %) in the range of composition given in parentheses; and that contains the following elements in the specified range of composition given in parentheses: chromium (15 to 20 atomic %), molybdenum (2 to 15 atomic %), tungsten (1 to 3 atomic %), boron (5 to 16 atomic %), carbon (3 to 16 atomic %), and the balance iron.

The aforedescribed amorphous alloy systems can further include additional elements, such as additional transition metal elements, including Nb, Cr, V, and Co. The additional elements can be present at less than or equal to about 30 wt %, such as less than or equal to about 20 wt %, such as less than or equal to about 10 wt %, such as less than or equal to about 5 wt %. In one embodiment, the additional, optional element is at least one of cobalt, manganese, zirconium, tantalum, niobium, tungsten, yttrium, titanium, vanadium and hafnium to form carbides and further improve wear and corrosion resistance. Further optional elements may include phosphorous, germanium and arsenic, totaling up to about 2%, and preferably less than 1%, to reduce melting point. Otherwise incidental impurities should be less than about 2% and preferably 0.5%.

In some embodiments a composition having an amorphous alloy can include a small amount of impurities. The impurity elements can be intentionally added to modify the properties of the composition, such as improving the mechanical properties (e.g., hardness, strength, fracture mechanism, etc.) and/or improving the corrosion resistance. Alternatively, the impurities can be present as inevitable, incidental impurities, such as those obtained as a byproduct of processing and manufacturing. The impurities can be less than or equal to about 10 wt %, such as about 5 wt %, such as about 2 wt %, such as about 1 wt %, such as about 0.5 wt %, such as about 0.1 wt %. In some embodiments, these percentages can be volume percentages instead of weight percentages. In one embodiment, the alloy sample/composition consists essentially of the amorphous alloy (with only a small incidental amount of impurities). In another embodiment, the composition consists of the amorphous alloy (with no observable trace of impurities).

Amorphous alloy systems can exhibit several desirable properties. For example, they can have a high hardness and/or hardness; a ferrous-based amorphous alloy can have particularly high yield strength and hardness. In one embodiment, an amorphous alloy can have a yield strength of about 200 ksi or higher, such as 250 ksi or higher, such as 400 ksi or higher, such as 500 ksi or higher, such as 600 ksi or higher. With respect to the hardness, in one embodiment, amorphous alloys can have a hardness value of above about 400 Vickers-100 mg, such as above about 450 Vickers-100 mg, such as above about 600 Vickers-100 mg, such as above about 800 Vickers-100 mg, such as above about 1000 Vickers-100 mg, such as above about 1100 Vickers-100 mg, such as above about 1200 Vickers-100 mg. An amorphous alloy can also have a very high elastic strain limit, such as at least about 1.2%, such as at least about 1.5%, such as at least about 1.6%, such as at least about 1.8%, such as at least about 2.0%. Amorphous alloys can also exhibit high strength-to weight ratios, particularly in the case of, for example, Ti-based and Fe-based alloys. They also can have high resistance to corrosion and high environmental durability, particularly, for example, the Zr-based and Ti-based alloys.

TABLE 1
Exemplary amorphous alloy compositions

| Alloy | Atm % | Atm % | Atm % | Atm % | Atm % | Atm % |
|---|---|---|---|---|---|---|
| 1 | Zr | Ti | Cu | Ni | Be | |
| | 41.20% | 13.80% | 12.50% | 10.00% | 22.50% | |
| 2 | Zr | Ti | Cu | Ni | Be | |
| | 44.00% | 11.00% | 10.00% | 10.00% | 25.00% | |
| 3 | Zr | Ti | Cu | Ni | Nb | Be |
| | 56.25% | 11.25% | 6.88% | 5.63% | 7.50% | 12.50% |
| 4 | Zr | Ti | Cu | Ni | Al | Be |
| | 64.75% | 5.60% | 14.90% | 11.15% | 2.60% | 1.00% |
| 5 | Zr | Ti | Cu | Ni | Al | |
| | 52.50% | 5.00% | 17.90% | 14.60% | 10.00% | |
| 6 | Zr | Nb | Cu | Ni | Al | |
| | 57.00% | 5.00% | 15.40% | 12.60% | 10.00% | |
| 7 | Zr | Cu | Ni | Al | Sn | |
| | 50.75% | 36.23% | 4.03% | 9.00% | 0.50% | |
| 8 | Zr | Ti | Cu | Ni | Be | |
| | 46.75% | 8.25% | 7.50% | 10.00% | 27.50% | |
| 9 | Zr | Ti | Ni | Be | | |
| | 21.67% | 43.33% | 7.50% | 27.50% | | |
| 10 | Zr | Ti | Cu | Be | | |
| | 35.00% | 30.00% | 7.50% | 27.50% | | |
| 11 | Zr | Ti | Co | Be | | |
| | 35.00% | 30.00% | 6.00% | 29.00% | | |
| 12 | Au | Ag | Pd | Cu | Si | |
| | 49.00% | 5.50% | 2.30% | 26.90% | 16.30% | |
| 13 | Au | Ag | Pd | Cu | Si | |
| | 50.90% | 3.00% | 2.30% | 27.80% | 16.00% | |
| 14 | Pt | Cu | Ni | P | | |
| | 57.50% | 14.70% | 5.30% | 22.50% | | |
| 15 | Zr | Ti | Nb | Cu | Be | |
| | 36.60% | 31.40% | 7.00% | 5.90% | 19.10% | |
| 16 | Zr | Ti | Nb | Cu | Be | |
| | 38.30% | 32.90% | 7.30% | 6.20% | 15.30% | |
| 17 | Zr | Ti | Nb | Cu | Be | |
| | 39.60% | 33.90% | 7.60% | 6.40% | 12.50% | |
| 18 | Cu | Ti | Zr | Ni | | |
| | 47.00% | 34.00% | 11.00% | 8.00% | | |
| 19 | Zr | Co | Al | | | |
| | 55.00% | 25.00% | 20.00% | | | |

### Characteristic Temperatures

An amorphous alloy can have several characteristic temperatures, including glass transition temperature Tg, crystallization temperature Tx, and melting temperature Tm. In some embodiments, each of Tg, Tx, and Tm, can refer to a temperature range, instead of a discrete value; thus, in some embodiments the term glass transition temperature, crystallization temperature, and melting temperature are used interchangeably with glass transition temperature range, crystallization temperature range, and melting temperature range, respectively. These temperatures are commonly known and can be measured by different techniques, one of which is Differential Scanning Calorimetry (DSC), which can be carried out at a heating rate of, for example, about 20° C./min.

In one embodiment, as the temperature increases, the glass transition temperature Tg of an amorphous alloy can refer to the temperature, or temperature ranges in some embodiments, at which the amorphous alloy begins to soften and the atoms become mobile. An amorphous alloy can have a higher heat capacity above the glass transition temperature than it does below the temperature, and thus this transition can allow the identification of Tg. With increasing temperature, the amorphous alloy can reach a crystallization temperature Tx, at which crystals begin to form. As crystallization in some embodiments is generally an exothermic reaction, crystallization can be observed as a dip in a DSC curve and Tx can be determined as the minimum temperature of that dip. An exemplary Tx for a Vitreloy can be, for example, about 500° C., and that for a platinum-based amorphous alloy can be, for example, about 300° C. For other alloy systems, the Tx can be higher or lower. It is noted that at the Tx, the amorphous alloy is generally not melting or melted, as Tx is generally below Tm.

Finally, as the temperature continues to increase, at the melting temperature Tm, the melting of the crystals can begin. Melting is an endothermic reaction, wherein heat is used to melt the crystal with minimal temperature change until the crystals are melted into a liquid phase. Accordingly, a melting transition can resemble a peak on a DSC curve, and Tm can be observed as the temperature at the maximum of the peak. For an amorphous alloy, the temperature difference ΔT between Tx and Tg can be used to denote a supercritical region (i.e., a “supercritical liquid region,” or a “supercritical region”), wherein at least a portion of the amorphous alloy retains and exhibits characteristics of an amorphous alloy, as opposed to a crystalline alloy. The portion can vary, including at least 40 wt %, at least 50 wt %, at least 60 wt %, at least 70 wt %, at least 80 wt %, at least 90 wt %, at least 99 wt %; or these percentages can be volume percentages instead of weight percentages.

### Making of Amorphous Alloys

The amorphous phase (i.e., amorphous alloy) within the alloy composition can be made by any suitable pre-existing method. In one embodiment, the method of making the alloy composition as raw material to be shaped can include first heating an alloy charge (e.g., mixture of alloying elements) to melt the charge and then rapid-cool the heated charge to the supercooled region of the alloy such that the alloy becomes at least partially amorphous. The additional steps can include (1) providing an alloy charge; heating the charge to a first temperature above a melting temperature Tm of the charge; and (3) quenching the heated charge to a second temperature below a glass transition temperature Tg of the charge to form a composition of the alloy, which composition is at least partially amorphous. The formed composition can then undergo the presently described joining methods. The final molded product may have at least one dimension that is greater than the critical casting thickness of the amorphous alloy composition thereof.

The alloy in the feedstock can be of any type, and it can be amorphous or crystalline, or both. In one embodiment, the feedstock is at least partially amorphous, such as at least substantially amorphous, such as entirely amorphous. In another embodiment, the feedstock is substantially not amorphous, such as being at least partially crystalline, such as at least substantially crystalline, such as being entirely crystalline.

Instead of an alloy charge, an alloy feedstock can be used. The feedstock can comprise an alloy that is at least partially amorphous. The feedstock can also be of any size and shape. For example, it can be sheet-like, flak-like, rod-like, wire-like, particle-like, or anything in between. The techniques of making amorphous alloy from crystalline alloys are known, and any of the known methods can be employed hereinto to fabricate the composition. Although different examples of methods of forming are described here, other similar forming processes or combinations of such can also be used. In one embodiment, the feedstock is heated to a first temperature that is above the melting temperature Tm of the alloy in the feedstock such that any crystals in the alloy can be melted. The heated and melted feedstock can then be rapid-cooled (or “quench”) to a second temperature that is below the Tg of the alloy to form the aforementioned composition, which can then be heated to be disposed and/or shaped. The rate of quenching and the temperature to be heated to can be determined by convention methods, such as utilizing a Time-Temperature-crystal Transformation (TTT) diagram. The provided sheets, shot, or any shape feedstock can have a small critical casting thickness, but the final part can have thickness that is either thinner or thicker than the critical casting thickness.

### Forming an Interlock

Because of their desirable properties, amorphous alloys can be used in a variety of applications, including forming a (mechanical) interlock between at least two components using an amorphous alloy-containing composition. “Forming” herein can involve shaping a composition into a desired or predetermined configuration, for example, to provide a locking mechanism. As will be discussed further below, forming can include, but is not limited to, thermoplastic forming, thermoplastic extrusion, casting, soldering, over-molding, and overcastting.

Parts

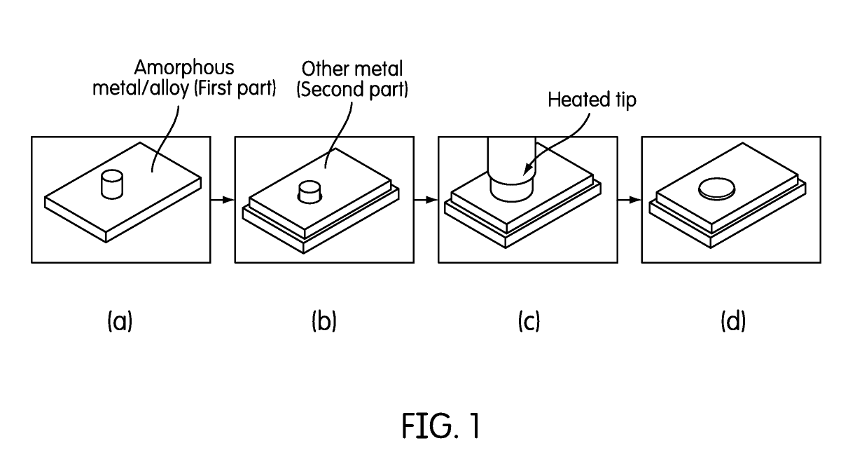

In one embodiment, a composition comprising an amorphous alloy can be used to form a joining mechanism, such as a mechanical interlock, to join at least two separate parts. More than two parts can be joined using the presently described methods. FIGS. 1(a)-1(d) illustrate a cartoon flow chart of such a process in one embodiment. As shown in FIGS. 1(a)-1(d), this exemplary joining method can be characterized by providing a first part comprising a protruding portion, wherein the protruding portion comprises an alloy that is at least partially amorphous; providing a second part comprising an opening; disposing the second part in proximity of the first part such that the protruding portion traversed through the opening; and mating the protruding portion and the opening at a first temperature to shape the protruding portion into an interlock joining the first part and the second part. Note that FIGS. 1(a)-1(d) are merely for illustration purpose and various alternative embodiments can exist. For example, the first part can be on top of the second part, and thus, reversing the image shown in FIG. 1(d) by 180 degrees.

Depending on the application, the parts to be joined as described below can be made of any suitable materials. For example, each or at least one of the parts can include a material that is crystalline, partially amorphous, substantially amorphous, or fully amorphous. The parts can have the same or different microstructure as the joining element (e.g., the mechanical interlock). For example, they can be amorphous, substantially amorphous, partially amorphous, or crystalline, or they can be different. As described above, the amorphous composition of the parts can be a homogeneous amorphous alloy or a composite having an amorphous alloy. In one embodiment, the composite can include an amorphous matrix phase surrounding a crystalline phase, such as a plurality of crystals. The crystals can be in any shape, including having a dendritic shape.

The materials of the parts can the same or different. For example, they can have the same chemical composition but different degrees of crystallinity. Alternatively, they can have different chemical compositions. In another embodiment, they can have different characteristic temperatures (as discussed above). Depending on the application, the parts can be a part of an electronic device or any type of part that can utilize the benefits of having the presently described joining mechanism. An electronic device is described in detail further below.

The first part can be one having a protruding portion, as shown in FIG. 1(a). The protruding portion (or protrusion) can comprise a composition comprising an alloy that is at least partially amorphous. In some embodiments, the first part can also be referred to as the “male structure.” The alloy can be, for example, at least substantially amorphous, such as fully amorphous. In one embodiment, the alloy comprises an alloy that is at least substantially amorphous, a composite containing an amorphous alloy, or a combination thereof. The protrusion can have any shape or size. For example, it can be shots, a sheet, a plate, a cylinder, a cube, a rectangular box, a sphere, an ellipsoid, a polyhedron, or an irregular shape, or anything in between

In one embodiment, the alloy can be a BMG. The alloy can be any of the aforedescribed alloys. For example, the alloys can comprise Zr, Hf, Ti, Cu, Ni, Pt, Pd, Fe, Mg, Au, La, Ag, Al, Mo, Nb, or combinations thereof. In some embodiments, the first part can act as a substrate. The protruding portion and the remaining portion of the first part can comprise the same materials or different materials. For example, in one embodiment, only the protrusion comprises an alloy that is at least partially amorphous while the remaining portion of the first part comprises a crystalline alloy. Alternatively, both the protrusion and the remaining portion of the first part comprise an alloy that is at least partially amorphous. Similarly, the protrusion and the remaining portion of the first part can comprise the same elements or different elements. For example, the protrusion can comprise a Zr-based alloy while the remaining portion can comprise an iron-based alloy. The protrusion can be introduced onto the remaining portion of the first part by any attachment mechanisms (e.g., soldering), or the protrusion can be formed as already a part of the first part when the first part was made.

The second part can have an opening, as shown in FIG. 1(b). Accordingly, in some embodiments, the second part can be referred to as a “female structure.” The second part can comprise any suitable material. The second part can comprise a metal, an alloy, or a compound. In one embodiment, the second part can comprise iron, titanium, copper, zirconium, aluminum, tungsten, their alloys, or combinations thereof. An iron alloy that can be used as the second part can, for example, be stainless steel, tool steel, etc. In general, the second part can comprise any material that can withstand at least the temperature used in forming the protrusion (e.g., as in thermoplastic forming) In one embodiment, the second part can have a crystallization temperature or a melting temperature that is higher than the crystallization of the alloy in the protrusion.

The second part can be a plate of any size or shape. Alternatively, the second part (and/or the first part) need not have a shape of a plate, or even need to be flat. For example, as long as the protrusion of the first part and the opening of the second part can be mated, the surrounding geometry can be any shape—e.g., flat (like a plate), domes, splines, discontinuities (i.e. corners). In one embodiment, the first and the second parts can be “concentric” or offsets of each another (e.g., with a constant separation). However, this need not be true all the time—for example, the contact/interlock can be made on a larger protruding section of the part. In some embodiments, the second part is a structural component of a device to be joined to the first part, and vice versa. The opening can be anywhere in the second part.

The opening on the second part can be anywhere in the second part. The opening can be anywhere in the second part. The opening can have any shape or size. For example, the opening can have a shape of a circle, elliptical, square, rectangle, or an irregular shape. Preferably the opening has a shape that is similar to that of the protrusion of the first part to facilitate the mating of the two parts. The size is also not limited, as the size of the opening would preferably be similar to that of the size of the protrusion of the first part. In one embodiment, the size of the opening is about the same as that of the protrusion. In another embodiment, the size of the opening is bigger than that of the protrusion in at least one dimension. The material of the second part can be the same or different from that of the first part. In one embodiment, the presently described methods unexpectedly can provide a superior joining mechanism to pre-existing soldering mechanisms in that the former allow chemically dissimilar metals to be joined, while the latter do not.

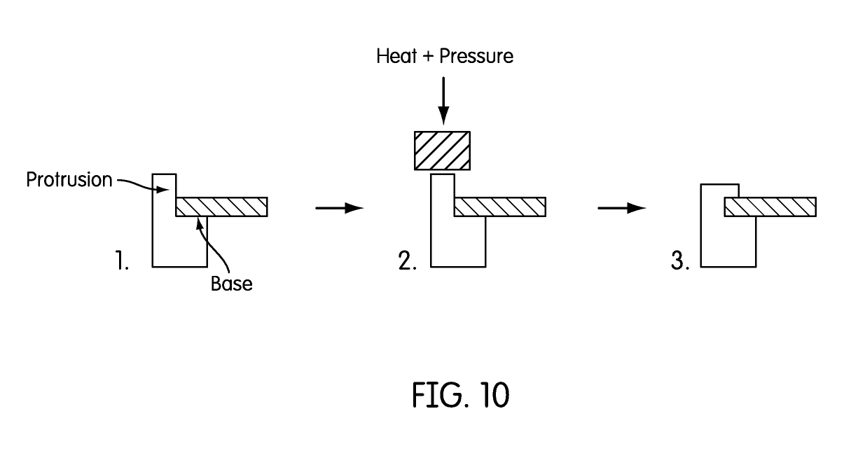

The second part need not have an opening. In other words, the assembly can be different than those aforedescribed. For example, the first part can have an undercut like structure. The structure can include a protruding portion and a base, as shown in FIG. 10(a). The undercut thus can resemble an edge, which can be of any shape and size. A portion of the second part can be contact with a portion of the protruding portion, particularly at the base thereof, as shown in FIG. 10(b). In one embodiment, one end of the second part can nestle in a portion of the undercut of the first part. The first part and the second part can be brought together by disposition, or they can come together as one assembly.

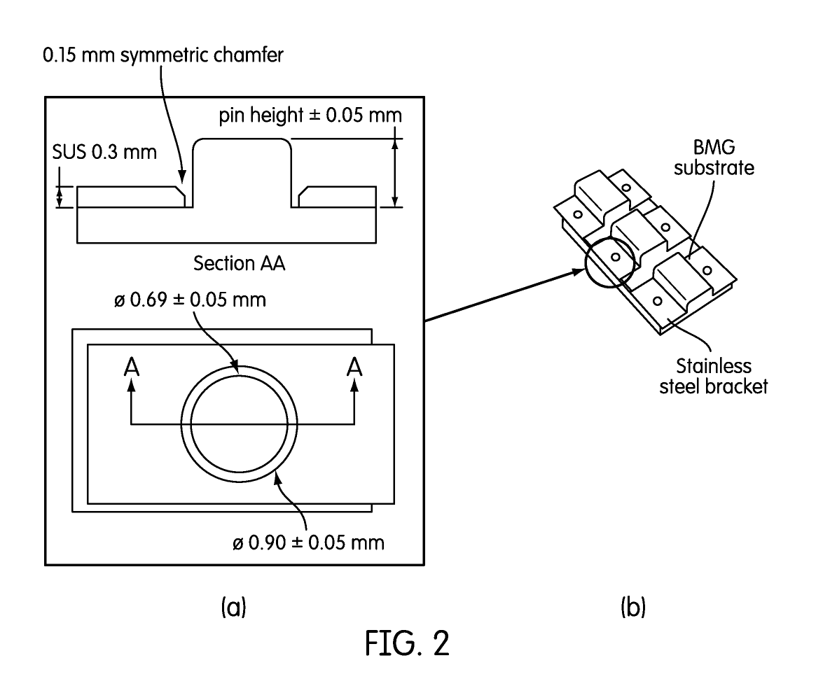

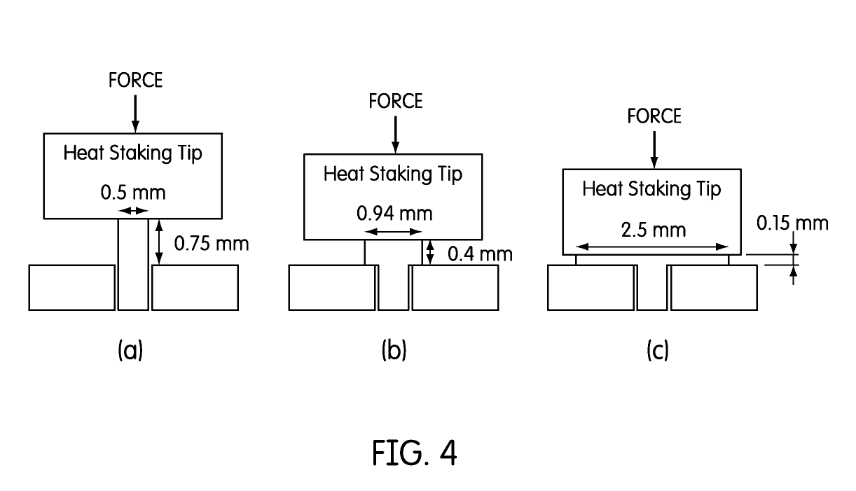

The disposing can be carried out to ensure that the protruding portion of the first part extends outwards of (or traverse through) the opening of the second part, as shown in FIG. 1(b). For example, in one embodiment, the second part comprises an opening and is disposed in proximity of the first part such that the protruding portion traverses through the opening. As aforedescribed, depending on the relative dimensions of the protrusion and the opening of the second part, there can be some spacing (or gap) between the protrusion and the wall of the opening, as seen in, for example, FIG. 4(a). FIG. 2(a) also provides a schematic illustration of the side view and top view of such an assembly. As a part of the fabrication process, a disposing step is not needed all the time. For example, in some incidences the first part and the second part can come as an assembly and the joining methods, as described below, are applied directly onto the assembly. FIGS. 2(a)-2(b) illustrate the assembly in one embodiment.

Mating

Once the second part is disposed over the second part (or they come as an assembly), mating can be carried out to form a joint. The forming mechanism can involve any of the shaping mechanisms aforedescribed. For example, the mechanism can involve thermoplastic forming. In one embodiment, the mechanism involves mating the protruding portion and the opening at a first temperature to shape the protruding portion into an interlock joining the first part and the second part. The mating can be carried out at a first temperature that is an elevated temperature relative to the temperature at which the disposing takes place.

Depending on the alloy composition, the first/elevated temperature can vary, but in most embodiments it is below the Tx of the alloy. As described above, the alloy can also be pre-heated so that a heating step can be skipped. In some embodiments, the temperature is preferably between about a glass transition temperature Tg and about a crystallization temperature Tx of the alloy. The term “about” has been defined elsewhere in the Specification, taking into the small variations. For example, the lower end of the temperature in the range can be about the Tg, referring to slightly below Tg, at Tg, and slightly above Tg. Similarly, the upper end of the temperature in the range can be about the Tx, referring to slightly below Tx, at Tx, and slightly above Tx. The value of the temperature can depend on the chemistry of the alloy of the protruding portion. For example, it can be lower or equal to about 750° C., such as lower or equal to about 700° C., such as lower or equal to about 650° C., such as lower or equal to about 600° C., such as lower or equal to about 500° C., such as lower or equal to about 450° C., such as lower or equal to about 400° C., such as lower or equal to about 350° C., such as lower or equal to about 300° C., such as lower or equal to about 250° C. In one embodiment, the temperature can be low relative to the melting temperature of the alloy.

In some embodiments, it is preferred that the temperature is at the higher end of the aforedescribed temperature range. It one embodiment, it is preferred that the temperature is close to the Tx but not exceeding it. A higher temperature in this case may decrease the viscosity, thereby facilitating the forming process. In one embodiment, the viscosity of an amorphous alloy in the supercooled liquid region can vary between 10¹² Pa·s at Tg down to 10⁵ Pa·s at Tx, which is generally considered the high temperature limit of the supercooled region. In some cases that as the temperature of the alloy increases (up to Tx), the viscosity becomes increasingly lower, and thus the rate at which the alloy crystallizes can speed up, thereby reducing the amount of time available for forming the alloy. However, the amorphous alloy in the supercooled region has high stability against crystallization and can exist as a highly viscous liquid. Liquids with such viscosities can undergo substantial plastic strain under an applied pressure. In contrast to solids, the liquid amorphous alloy can deform locally, which can drastically lower the required energy for cutting and forming.

The matting herein can involve either compressing the protruding portion towards the opening or compressing opening towards the protruding portion. The compression can be carried out in a manner as shown in FIGS. 1(a)-1(d), in which the protrusion of the first part and the opening of the second part are brought into closer proximity. Alternatively, the compression can be carried out by compressing the protrusion of the first part towards the second part, and hence the base of the protrusion, as shown in FIGS. 10(a)-10(c). The latter embodiment can be particularly useful in jewelry application. For example, the first part (and/or the second part) can be a part of a bezel, such as continuous bezel, as in a watch or in a ring. The parts can also be a part of the prongs of a ring, in which a jam stone is set. For example, each of the prongs can be a protrusion that has been compressed to form an interlock to lock the jam stone.

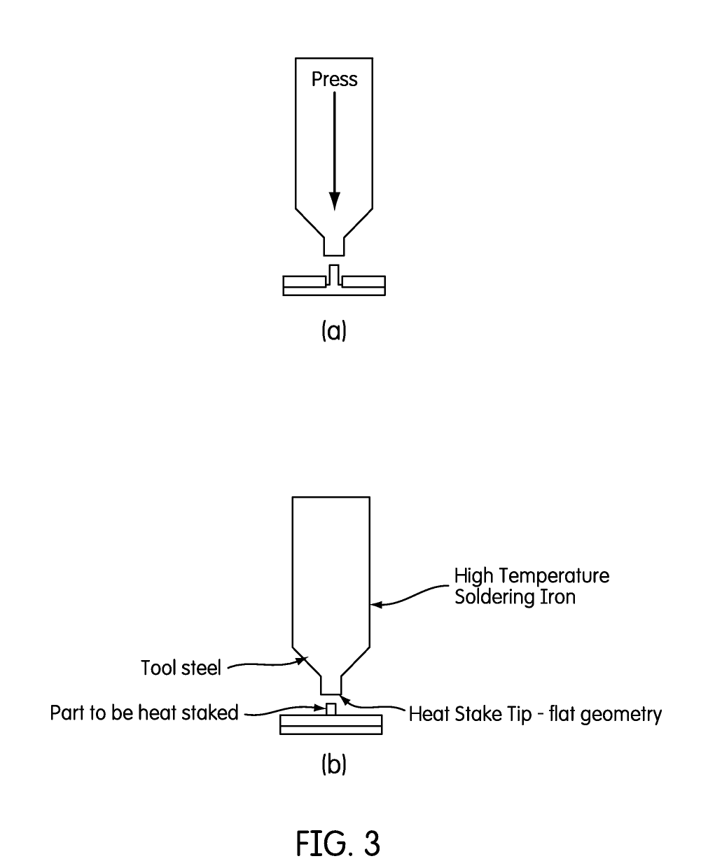

The compression can be carried out with a separate structure, such as a tip. The schematic of such a tip in one embodiment is shown in FIGS. 3(a)-3(b). The tip can have any shape or size depending on the application and the shape and size of the protrusion of the first part. For example, the tip can have a form of a plunger with a flat end, as shown in the schematic of FIGS. 3(a)-3(b). Alternatively, the tip can have a hemispherical end, a pyramidal end, or an end with an irregular shape. In one embodiment, the surface area of the tip is greater than that of the protrusion. In another embodiment, the two surface areas are comparable. The tip is preferably heated to at least the aforementioned elevated (or first) temperature to facilitate the mating (including shaping and compressing) process. In one embodiment, the tip can be heated to a temperature higher than the aforementioned elevated temperature to ensure adequate temperature. The tip can be heated by any conventional heating mechanisms. For example, it can be heated inductively, conductively, radiatively, convectively (e.g., with a flow of hot gas or liquid).

The tip can comprise any suitable materials. For example, the tip can comprise iron and its alloys. For example, the tip can comprise a metal or alloy, such as tungsten, stainless steel, tool steel, or combinations thereof. Alternatively, the tip can comprise a ceramic. In some embodiments herein, the tip is referred to as a “heat staking tip.” The compression can be carried out for any suitable period of time, depending on the geometry and chemistry of the protrusion. For example, the period can be less than or equal to about 20 seconds, such as less than or equal to about 15 seconds, less than or equal to about 10 seconds, less than or equal to about 5 seconds, less than or equal to about 1 seconds, less than or equal to about 500 ms, less than or equal to about 200 ms, less than or equal to about 100 ms. In one embodiment, it is preferable that the period is at least 50 ms, such as at least 100 ms, such as at least 500 ms. Furthermore, the stress imparted during mating (e.g., by the tip) can be of any value, depending on the materials involved. For example, the stress can be about the yield strength of the amorphous alloy in the protrusion at room temperature, or the stress can be lower or higher than the yield strength. The stress need not be constant, although it can be. For example, the stress can change, such as increase or decrease, with a change of applied strain to the protrusion. In one embodiment, the faster the amorphous alloy is strained at a particular viscosity, the higher the force (and thus stress) the parts of the system would be subjected to.

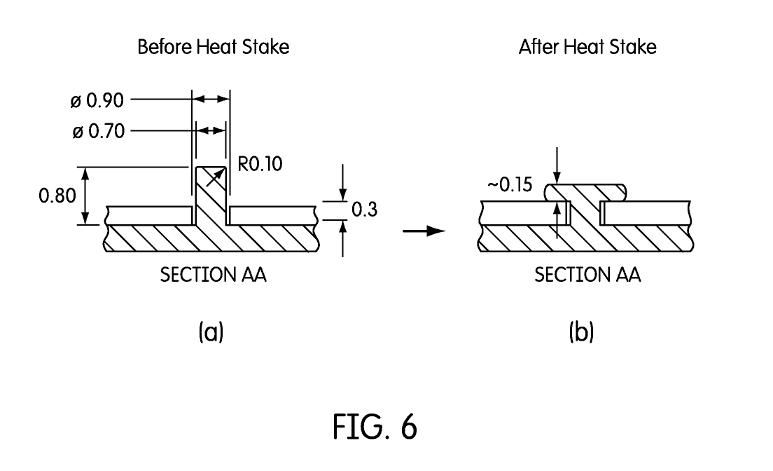

As the protrusion is compressed, at least a portion of the alloy can be thermoplastically deformed, as shown in the schematic diagrams shown in FIGS. 4(a)-4(c). For example, as shown in the figures, the upper portion of the protrusion is deformed to spread out horizontally as a result of a vertical force. In particular, as shown in the figures, a 0.5 mm×0.75 mm portion can be compressed into a 0.94 mm×0.4 mm, and even further into a 2.5 mm×0.15 mm portion. FIGS. 6(a)-6(b) provide an illustration of the compression/shaping process in an alternative embodiment. Specifically, FIG. 6(a) provides a cross-sectional view of an assembly with the protrusion extending outwards of the opening of the second part. After the protrusion is compressed by a heat staking tip, as shown in FIG. 6(b), the geometry and dimensions of the protrusion can change.

After shaping during mating, the “shaped” protrusion (now in the shape of an interlock in one embodiment, as shown in FIG. 6(b)), can be cooled to a temperature below the Tg of the alloy to harden or solidify. The cooling time can depend on the chemical composition of the alloy. During the cooling step, the compressive pressure applied during the forming step can be maintained. The pressure can be decreased, the same, or increased relative to that used in the disposing step. Accordingly, in one embodiment, with the aid of the applied pressure, the interlock can continue to be shaped during the cooling step.

Subsequent to the mating process, the assembly, particularly the alloy composition in the protrusion can be cooled. The alloy composition can be cooled to below the Tg of the composition, such as finally to the ambient temperature. The resultant cooled composition is at least partially amorphous, such as at least substantially amorphous, such as completely amorphous. In one embodiment where there are two metal parts, the amorphous alloy molded article can create a mechanical interlock between the two metal parts, with little inter-diffusion of the metal species from the parts into the molded article. The parameters used during mating, including compressing, heating, and cooling can be evaluated and optimized.

In some embodiments, the heating history of an amorphous alloy can be cumulative. Thus, the steps of heating, compressive, and cooling can be repeated many times, as long as the total heating time in the heating history is less than that would trigger crystal formation. This can provide an unexpected benefit of having the ability to reshape, remold, and/or re-bond the interfacial layer and the parts.

The compression can be carried out under a partial vacuum, such as low vacuum, or even high vacuum, to avoid reaction of the alloy with air. In one embodiment, the vacuum environment can be at about 10⁻² torr or less, such as at about 10⁻³ torr or less, such as at about 10⁻⁴ torr or less. Alternatively, the step of heating and/or disposing can be carried out in an inert atmosphere, such as in argon, nitrogen, helium, or mixtures thereof. Non-inert gas, such as ambient air, can also be used, if they are suitable for the application. In another embodiment, it can be carried in a combination of a partial vacuum and an inert atmosphere. Carrying out the compression/shaping process in these types of atmosphere can prevent contamination of the final product (i.e., the interlock) with impurities.

The presently described methods can also prevent contamination of the final product as a result of the inter-diffusion. In one embodiment wherein thermoplastic forming is used as the shaping mechanism, the forming process can effectively prevent inter-diffusion of the chemical elements between the protrusion (and also to an extent, the first part), the second part, and the heated tip. As a result, in one embodiment, the resultant interlock is substantially free of the elements diffused from the second part and/or the tip, unless the element is a common element already present in the alloy composition in the molded article before the joining process. For example, as a result of the forming methods described herein, minimal diffusion of elements from the parts occurs. Thus, the molded article is substantially free of any elements diffused from the part(s), such as entirely free of any elements diffused from the part(s). This can have the benefit of avoiding contamination of the resultant lock form and/or erosion of the surface of the parts with which the interlock is in contact. In the case of the interlock (or protrusion) sharing some common elements with any of the parts, this lack of diffusion refers to the diffusion of the elements from the parts, as opposed to the presence of the common elements already present in the molded article.

The resultant structure (e.g., interlock in one embodiment) can comprise an alloy that is at least substantially amorphous, a composite containing an amorphous alloy, or a combination thereof. In one embodiment, the degree of crystallinity of the protrusion before and after the mating step remains comparable. In another embodiment, substantially no phase transformation occurs during the mating step.

The presently described methods allow the joining element made of the amorphous alloy composition to be formed at a lower temperature than convention methods such as soldering, welding, or braising—i.e., often taking place at around 1000° C. or higher, as opposed to the temperature used in the presently described methods (see above). One advantage of the presently described methods is thus that the lower temperature may result in smaller amount of damage to the parts being joined as a result of the high temperature operation in the conventional joining methods.

Also, the presently described methods surprisingly can allow the fabrication of an joining element to be made with very small volume shrinkage during the cooling step; this is in stark contrast to the convention bonding method such as braising. In one embodiment, the volume shrinkage (of the formed interfacial layer/seal relative to the composite disposed onto the surface of a part) can be less than about 1%, such as less than about 0.8%, such as less than about 0.6%, such as less than about 0.5%, such as less than about 0.3%, such as less than about 0.2%, such as less than about 0.1%, such as less than about 0.09%. Such a small volume shrinkage can allow an intimate contact between the interfacial layer or seal and the part(s); as a result, the seal can be impermeable to fluid, as described above.

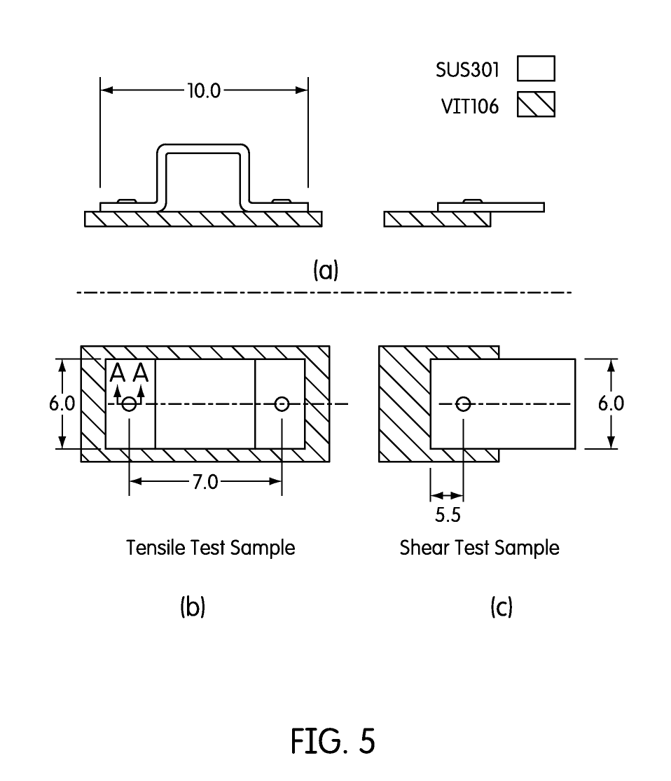

As a result, the interlock/joining element can form an intimate contact with at least one surface of the second part, as shown in FIG. 5(a). Because of the intimate contact, the interlock can form an effective seal between the first and second parts. For example, the intimate contact can allow the interlock to form an airtight seal that is impermeable to fluid—gas or liquid.

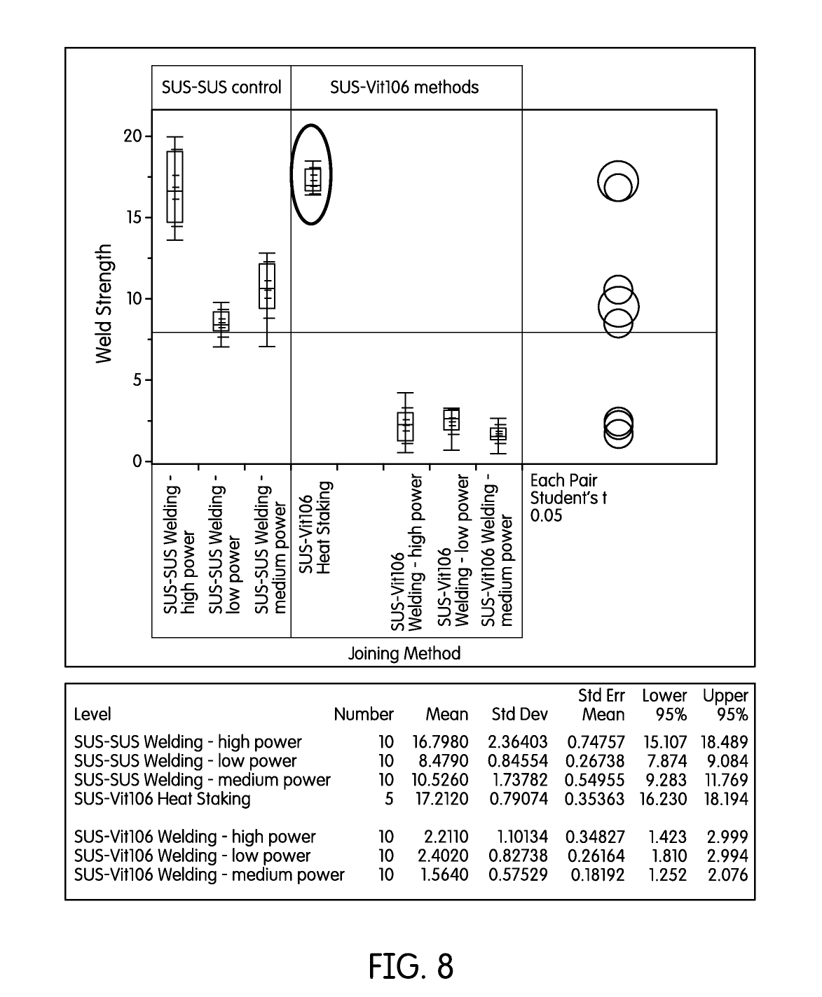

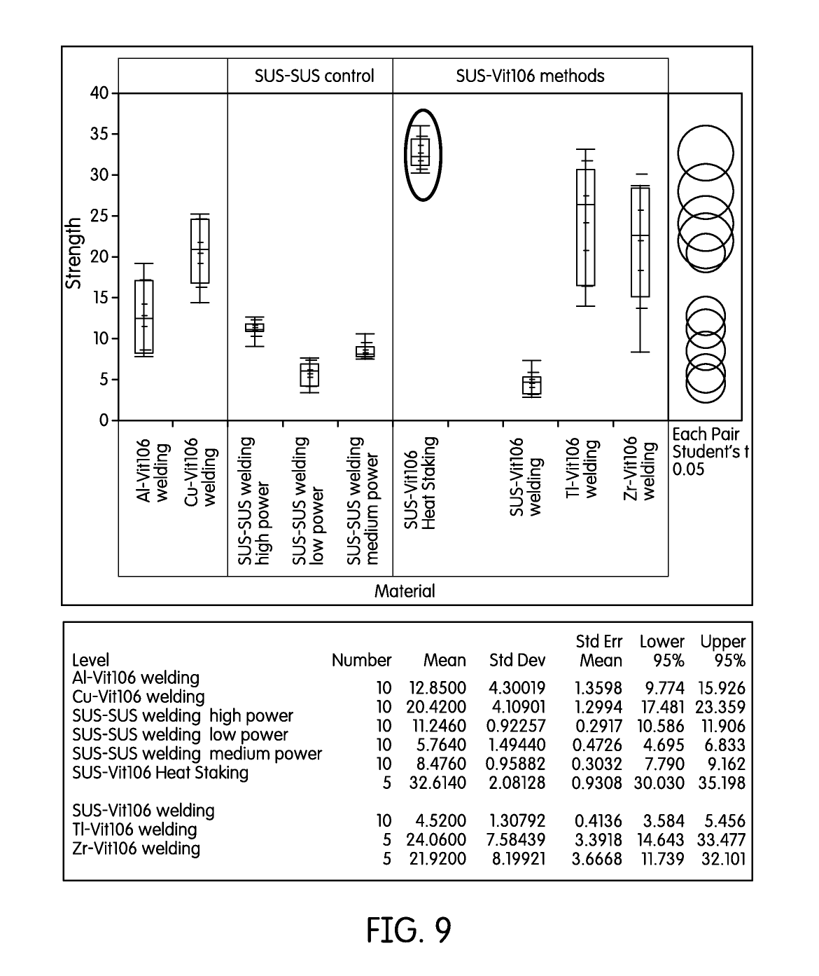

The interlock can have superior properties. In addition to having the properties of metallic glass that is inert to chemical contamination (as aforedescribed), the interlock can have superior mechanical properties. For example, the interlock can have a strength that is comparable or even higher than conventional welding joints (of the same material). As shown in FIG. 8, the tensile strength of the interlock in one embodiment (circled) can be above 10 kilogram-force (“kgf”), such as above 15 kgf, such as above 18 kgf, such as above 20 kgf. Furthermore, as shown in FIG. 9, the presently described interlock in one embodiment can have higher shear strength than all of the conventional methods the inventors have tested to date. Specifically, the shear strength can be more than about 30 kgf, such as more than about 35 kgf, such as more than about 40 kgf. One advantage of using the presently described joining method is thus a strong joint without the need for using a fastener, welding, soldering, etc., as in the conventional operations.

### Applications

The presently described methods can be applied to joining different structural components, such as those in a device or in a jewelry. The device can be an electronic device. The jewelry can include a bezel, such as a continuous bezel, or discrete prongs, as in prongs in a ring wherein a jam stone is set.

An electronic device herein can refer to any electronic device known in the art. For example, it can be a telephone, such as a cell phone, and a land-line phone, or any communication device, such as a smart phone, including, for example an iPhone™, and an electronic email sending/receiving device. It can be a part of a display, such as a digital display, a TV monitor, an electronic-book reader, a portable web-browser (e.g., iPad™), and a computer monitor. It can also be an entertainment device, including portable DVD player, conventional DVD player, Blue-Ray disk player, video game console, music player, such as a portable music player (e.g., iPod™), etc. It can also be a part of a device that provides control, such as controlling the streaming of images, videos, sounds (e.g., Apple TV™), or it can be a remote control for an electronic device. It can be a part of a computer or its accessories, such as the hard drive tower housing or casing, laptop housing, laptop keyboard, laptop track pad, desktop keyboard, mouse, and speaker. The article can also be applied to a device such as a watch or a clock.

### Non-Limiting Working Examples

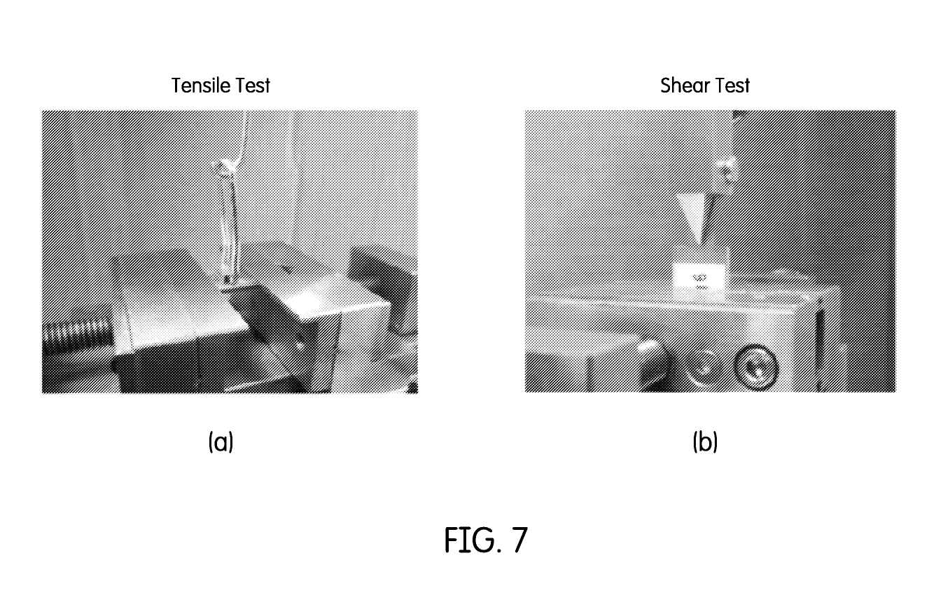

A mechanical interlock was formed to join two parts and to create different test samples for the measurements of mechanical properties. The geometries of the samples are illustrated in the schematics in FIGS. 5(a)-5(c), and the cross-sectional views thereof are provided in FIG. 6(a)-6(b). FIG. 7(a) and FIG. 7(b) provide photographs of a tensile test sample and a shear test sample, respectively, in the experiments conducted.

The amorphous alloy used in the protruding portion is a Zr-based alloy, sometimes referred to as Vitreloy 106. The chemical composition there of is Zr_{67.5}Cu_{12.79}Ni_{9.79}Nb_{6.07}Al_{3.53} (in wt %). The substrate (first part) was stainless steel, and the heat stake tool tip was made of tool steel mounted on high temperature soldering iron. The tip temperature kept at about 450° C. The press time of the tip on the protrusion was between about 5-10 seconds. The tip was pressed by hand. FIG. 8 and FIG. 9 show the results.

For comparison, other stainless-steal to stainless welds and stainless steel to the Vitreloy 106 welds were provided in FIG. 8, which shows the tensile test results. As comparative negative controls, stainless steel substrates were soldered to stainless part, as opposed to the Zr-based alloy jointed by interlock with a stainless steel substrate. It is seen from FIG. 8 that heat staking (present method) (circle) was the only joining method showing tensile strength equivalent to that of the strongest stainless steel-to-stainless steal welds—a mean of greater than about 17 kgf.

FIG. 9 demonstrates the shear strength results. As shown in FIG. 9, heat staking (circled) shows the highest shear strength results of all the joining methods tested a mean of greater than about 32.6 kgf, as compared to about 20 kgf as the highest of the conventional joint.

The articles “a” and “an” are used herein to refer to one or to more than one (i.e., to at least one) of the grammatical object of the article. By way of example, “a polymer resin” means one polymer resin or more than one polymer resin. Any ranges cited herein are inclusive. The terms “substantially” and “about” used throughout this Specification are used to describe and account for small fluctuations. For example, they can refer to less than or equal to ±10%, such as less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

What is claimed:

1. A method, comprising:
providing a first part comprising a protruding portion, wherein the protruding portion comprises an alloy that is at least partially amorphous;
providing a second part comprising an opening;
disposing the second part in proximity of the first part such that the protruding portion traverses through the opening; and
mating the protruding portion and the opening at a first temperature to shape the protruding portion into an interlock joining the first part and the second part.

2. The method of claim 1, wherein the alloy is a bulk amorphous alloy.

3. The method of claim 1, wherein the alloy comprises Zr, Hf, Ti, Cu, Ni, Pt, Pd, Fe, Mg, Au, La, Ag, Al, Mo, Nb, or combinations thereof.

4. The method of claim 1, wherein the protruding portion comprises a different material than the remaining portion of the first part.

5. The method of claim 1, wherein the second part comprises iron, titanium, copper, zirconium, aluminum, tungsten, their alloys, or combinations thereof.

6. The method of claim 1, wherein the second part and the first part comprise different materials.

7. The method of claim 1, wherein the opening is larger than the protruding portion in at least one dimension.

8. The method of claim 1, wherein the first temperature is between about a glass transition temperature Tg and about a crystallization temperature Tx of the alloy.

9. The method of claim 1, wherein the mating comprise compressing the protruding portion towards the opening.

10. The method of claim 1, wherein the mating comprise compressing opening towards the protruding portion.

11. A method, comprising:
providing an assembly, comprising:
a first part comprising a protruding portion, wherein the protruding portion comprises an alloy that is at least partially amorphous;
a second part comprising an opening; the second part being disposed in proximity of the first part such that the protruding portion traverses through the opening; and
mating the protruding portion and the opening with a heated tip at a temperature between about a glass transition temperature Tg and about a crystallization temperature Tx of the alloy to shape the protruding portion into an interlock joining the first part and the second part.

12. The method of claim 11, further comprising cooling the interlock to a temperature below the Tg of the alloy.

13. The method of claim 11, wherein the protruding portion does not permit inter-diffusion of elements of the protruding portion, the second part, and the heated tip.

14. The method of claim 11, wherein the tip comprises iron

15. The method of claim 11, wherein the compressing is carried out under at least partially vacuum, in an inert atmosphere, or both.

16. The method of claim 11, wherein the alloy comprises an alloy that is at least substantially amorphous, a composite containing an amorphous alloy, or a combination thereof.

17. The method of claim 11, wherein the interlock is in intimate contact with at least one surface of the second part.

18. The method of claim 11, wherein the temperature is lower or equal to about 500° C.

19. The method of claim 11, wherein the compressing is carried out for less than or equal to about 10 seconds.

20. The method of claim 11, wherein the assembly is a part of an electronic device.

21. The method of claim 1, wherein the interlock comprises an alloy that is at least substantially amorphous, a composite containing an amorphous alloy, or a combination thereof.

22. The method of claim 11, wherein the interlock has a tensile strength of 10 kgf.

23. The method of claim 11, wherein the interlock has a shear strength of 30 kgf.

24. The method of claim 1, wherein the mating comprises expanding the protruding portion towards the opening.

25. The method of claim 1, wherein the mating comprises compressing the opening towards the protruding portion.

26. A device comprising:
a first part comprising a protruding portion, wherein the protruding portion comprises an alloy that is at least partially amorphous;
a second part comprising an opening; the second part being disposed in proximity of the first part such that the protruding portion traverses through the opening; and
an interlock joining the first part and the second part, wherein the protruding portion and the opening are interconnected to shape the protruding portion into the interlock.

27. The device of claim 26, wherein the alloy is a bulk amorphous alloy.

28. The device of claim 26, wherein the alloy comprises Zr, Hf, Ti, Cu, Ni, Pt, Pd, Fe, Mg, Au, La, Ag, Al, Mo, Nb, or combinations thereof.

29. The device of claim 26, wherein the protruding portion comprises a different material than the remaining portion of the first part.

30. The device of claim 26, wherein the second part comprises iron, titanium, copper, zirconium, aluminum, tungsten, their alloys, or combinations thereof.

31. A method, comprising:
providing an assembly, comprising:
a first part comprising a protruding portion, wherein the protruding portion comprises an alloy that is at least partially amorphous;
a second part that is in contact with a portion of a base of the protruding portion; and
compressing the protruding portion towards the second part at a temperature between about a glass transition temperature Tg and about a crystallization temperature Tx of the alloy to shape the protruding portion into an interlock joining the first part and the second part.

32. The method of claim 31, wherein the alloy is a bulk amorphous alloy.

33. The method of claim 31, wherein the at least one of the first part and the second part is a continuous bezel or discrete prongs.

34. The method of claim 31, wherein the compressing is carried out with a heated tip.
